(19) United States
(12) Patent Application Publication
(10) Pub. No.: US 2018/0195599 A1
(43) Pub. Date: Jul. 12, 2018

(54) SOUND DAMPENING COATING FOR A TRANSMISSION HOUSING AND METHOD FOR APPLYING A SOUND DAMPENING COATING ON A TRANSMISSION HOUSING

(71) Applicant: GM GLOBAL TECHNOLOGY OPERATIONS LLC, DETROIT, MI (US)

(72) Inventors: Baden Michael Powell, Tecumseh Ontario (CA); Frank Loscher, Tecumseh (CA); John L. Horvath, Oxford, MI (US)

(21) Appl. No.: 15/404,449

(22) Filed: Jan. 12, 2017

(51) Int. Cl. F16H 57/028; B05D 1/02; B05D 1/32; B05D 3/10; B05D 1/18; B05D 7/00; B29C 51/10

(52) U.S. Cl. CPC F16H 57/028; B05D 1/02; B05D 1/32; B05D 3/108; B29L 2031/30; B05D 7/52; B29C 51/10; F16H 2700/00; B05D 1/18

(57) ABSTRACT

A method for applying a sound dampening coating on a surface of a vehicle transmission housing includes providing the transmission housing, and applying a sound dampening material directly on a surface of the transmission housing.

### FIELD

The present disclosure relates to a sound dampening coating for a vehicle transmission housing and a method for applying a sound dampening coating on a transmission housing.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

A vehicle transmission may include a housing that encloses components which transmit power from a prime mover to a drive member. The power transmitting components may generate vibrations and/or noise that may be communicated to the housing and from the housing to the surroundings. Those surroundings may include a vehicle body that houses a passenger compartment. The noise generated by the transmission may be communicated through the vehicle body and may be unpleasant or undesirable to an occupant of the vehicle.

Conventional approaches to attenuating this noise and/or vibration have taken many alternative approaches, sometimes working in combination. One approach has been to mount a transmission cover onto the outside of the transmission housing. This cover is generally spaced a distance away from the external surface of the transmission housing. While this may be generally effective for attenuating the noise, this approach has several disadvantages. For example, in order to mount these covers onto the housing they require an opening and/or hole to accommodate a fastener such as, for example, with a vibration isolating damper material lining the hole which then receives a protrusion or stud which extends from the surface of the housing. When mounting the cover, it must be carefully positioned so that the studs and holes align and then the cover is pressed onto the housing such that the studs are forced into the holes. In this manner, the cover is mounted on the transmission housing. Not only is this a somewhat complicated mounting/assembly process, but the transmission housing must be designed and carefully shaped to include these studs. Further, the cover must be designed to include multiple holes not only to accommodate the mounting fasteners but also to provide access to certain portions of the housing for inspection, maintenance, service and/or to provide visibility for labeling appearing on the surface of the housing. Each of these holes reduce the effectiveness of the sound dampening function. Further, each of these additional features increase the cost of the housing and the cover. Additionally, the mounting studs and/or fasteners are at risk of being broken and/or damaged during handling. A very similar mounting method may rely upon multiple holes in the cover and extending into the transmission housing that may be adapted to receive a threaded fastener. These holes require additional and costly machining of the transmission housing that otherwise would not be necessary.

Having to mount such a cover also may cause issues during the assembly process, if the assembler does not push the cover all the way onto the studs, then the sound dampening effect may be reduced. Further, ensuring that the cover is properly seated onto the transmission housing leads to its own difficulties, processes are required that ensure proper seating. How this is done can result in an increased cost.

Further, automotive manufacturers often manufacture multiple different transmission housings which each require their own specially designed transmission cover. This results in an undesirable proliferation in part count, handling, storage and expense.

As packaging and space concerns increase and transmissions become more complex, the amount of free space within each housing, which might otherwise reduce noise communication, is minimized. This reduction in free space increases the necessity of minimizing the noise which is increasingly being generated by these transmissions.

### SUMMARY

In an exemplary aspect, a transmission for coupling a prime mover to a drive member in a vehicle includes a housing enclosing power transmitting components coupled to the prime mover and drive member, and a sound dampening coating directly on a surface of the housing.

In another exemplary aspect, the sound dampening coating varies in thickness across the surface.

In another exemplary aspect, the surface includes an external surface of the housing.

In another exemplary aspect, the surface includes an inner surface of the housing.

In another exemplary aspect, the transmission further includes a second sound dampening coating on the sound dampening coating.

In another exemplary aspect, the characteristics of the sound dampening coating vary across a thickness of the coating.

In another exemplary aspect, a method for applying a sound dampening coating on a surface of a vehicle transmission housing includes providing the transmission housing, and applying a sound dampening material directly on a surface of the transmission housing.

In another exemplary aspect, applying the sound dampening material includes spraying the sound dampening material on the surface.

In another exemplary aspect, the method further includes masking portions of the surface prior to spraying the sound dampening material on the surface.

In another exemplary aspect, applying the sound dampening material comprises vacuum forming the sound dampening material on the surface.

In another exemplary aspect, the method further includes applying heat to cure the sound dampening material on the surface.

In another exemplary aspect, applying the sound dampening material includes dipping the transmission housing in liquid sound dampening material.

In another exemplary aspect, applying includes varying a thickness of the sound dampening material on the surface.

In another exemplary aspect, the method further includes subsequently applying a second sound dampening material having characteristics different than the previously applied sound dampening material.

In another exemplary aspect, the method further includes preparing the surface prior to applying the sound dampening material.

In another exemplary aspect, the surface forms a portion of an external surface of the transmission housing.

In another exemplary aspect, the surface forms a portion of an inner surface of the transmission housing.

In this manner, the cost associated with providing a separate component for the cover is entirely avoided, the complex and expensive conventional fastening systems such as, for example, studs, protrusions and/or machined holes in the transmission housing for mounting a cover and risk of damage to these features during handling are entirely avoided Further, the potential problems with mounting the covers are avoided, sound deadening material may be positioned and more accurately applied and targeted to those surfaces of the transmission housing that may benefit most from the coating, and the overall process may be greatly simplified. Additionally, applying the material directly to the housing in accordance with the present disclosure enables intimate, direct contact with those portions of the housing surface which have not previously been possible due to the complexity of the surface.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a flowchart illustrating a method in accordance with an exemplary embodiment of the present disclosure.

### DETAILED DESCRIPTION

An exemplary embodiment of the present disclosure includes a transmission housing enclosing power transmitting components with a sound dampening coating applied directly on a surface of the housing. In contrast, with conventional sound dampening systems and methods, the present invention completely avoids the cost and complexity of providing an entirely separate transmission housing acoustic cover.

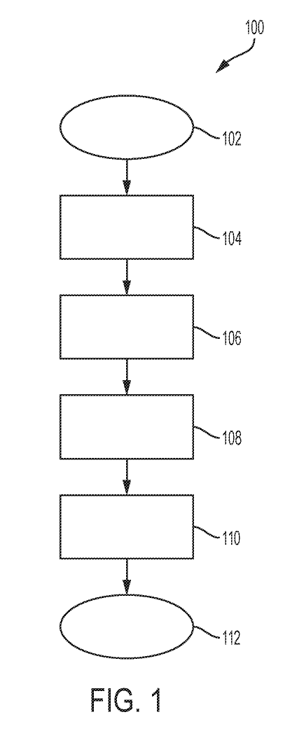

FIG. 1 is a flowchart illustrating a method 100 in accordance with an exemplary embodiment of the present disclosure. The method starts at step 102 and continues to step 104. In step 104, the method provides a transmission housing and continues to step 106. In step 106, the method cleans a surface of the transmission housing and continues to step 108. In step 108, the method applies a sound dampening material on a surface of the transmission housing and continues to step 110. In step 110, the method cures the applied dampening material by, for example, permitting an elapse of time, applying heat or a vacuum, or the like and continues to step 112. The method ends in step 112.

The application of the sound dampening material may be done in any manner without limitation. For example, the sound dampening material may be applied by spraying the material on the surface of the housing, painted on, vacuum formed onto the housing, molded onto the housing during a casting process, the housing may be dipped into a liquid solution of the sound dampening material and subsequently cured and/or dried onto the surface, and the like without limitation. The exemplary method provides contact between the surface of the housing and the sound dampening material such that the sound reducing coating is directly on the surface of the housing as opposed to being spaced a distance off the housing as has conventionally been done with pre-existing transmission acoustic shields or covers.

In an exemplary method, the material may be selectively applied only to those portions of the housing surface where such material may be most effective. For example, some hybrid automotive transmission include an electric motor which may generate substantial noise. The sound dampening material may be applied only to those portions of the housing which receive the greatest portion of the sound from the motor. In this manner, the amount of sound dampening material may be minimized and optimized to effectively provide sound dampening effects for those portions of the housing which may most benefit.

As explained above, in contrast to conventional methods, the present methods and systems obviate the need to maintain, track, and store a large variety of acoustic shields. When applied directly to the housing, the large variances in the shape of the housing surfaces between the different types of transmission components can be easily accommodated.

Optionally, for those applications where a housing surface may need to be exposed, prior to the coating process, areas may be masked to limit application of the sound deadening coating directly onto the housing surface. Such areas may include access openings, areas which include indicia or markings on the housing surface, vent holes, or the like.

The coating may be applied using varying methods such as, for example, spraying, painting, brushing, vacuum forming, dipping the housing and the like without limitation.

While the present disclosure refers generally to transmission housings, those of ordinary skill in the art understand that the present methods and systems are intended to include any housing which may incorporate power transmission components such as, for example, transmission housings, power takeoff housings, power transmission unit housings, differential housings, other surfaces generally defining the exterior surface of the transmission, and the like without limitation.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A transmission for coupling a prime mover to a drive member in a vehicle, the transmission comprising:
a housing enclosing power transmitting components coupled to the prime mover and drive member; and
a sound dampening coating directly on a surface of the housing.

2. The transmission of claim 1, wherein the sound dampening coating varies in thickness across the surface.

3. The transmission of claim 1, wherein the surface comprises an external surface of the housing.

4. The transmission of claim 1, wherein the surface comprises an inner surface of the housing.

5. The transmission of claim 1, further comprising a second sound dampening coating on the sound dampening coating.

6. The transmission of claim 1, wherein the characteristics of the sound dampening coating vary across a thickness of the coating.

7. A method for applying a sound dampening coating on a surface of a vehicle transmission housing, the method comprising:
providing the transmission housing; and
applying a sound dampening material directly on a surface of the transmission housing.

8. The method of claim 7, wherein applying the sound dampening material comprises spraying the sound dampening material on the surface.

9. The method of claim 8, further comprising masking portions of the surface prior to spraying the sound dampening material on the surface.

10. The method of claim 7, wherein applying the sound dampening material comprises vacuum forming the sound dampening material on the surface.

11. The method of claim 7, further comprises applying heat to cure the sound dampening material on the surface.

12. The method of claim 7, wherein applying the sound dampening material comprises dipping the transmission housing in liquid sound dampening material.

13. The method of claim 7, wherein the applying comprises varying a thickness of the sound dampening material on the surface.

14. The method of claim 7, further comprising subsequently applying a second sound dampening material having characteristics different than the previously applied sound dampening material.

15. The method of claim 7, further comprising preparing the surface prior to applying the sound dampening material.

16. The method of claim 7, wherein the surface forms a portion of an external surface of the transmission housing.

17. The method of claim 7, wherein the surface forms a portion of an inner surface of the transmission housing.
